(19) United States
(12) Patent Application Publication
(10) Pub. No.: US 2020/0241744 A1
(43) Pub. Date: Jul. 30, 2020

(54) JOYSTICK TOOL FOR NAVIGATING THROUGH PRODUCTIVITY DOCUMENTS

(71) Applicant: Apple Inc., Cupertino, CA (US)

(72) Inventors: David Mowat Findlay, Freeport, PA (US); Jonathan Robert Speicher, Pittsburgh, PA (US)

(21) Appl. No.: 16/261,342

(22) Filed: Jan. 29, 2019

(51) Int. Cl. G06F 3/0488; G06F 3/0485

(52) U.S. Cl. CPC G06F 3/04886; G06F 3/0485

(57) ABSTRACT

The present disclosure relates to a joystick tool for navigating through a productivity document. A method for adjusting a viewable portion of a document in a document authoring application may include displaying, on a display, at least a portion of a productivity document having an associated bounding area. The method may also include displaying, at a location within the productivity document, a joystick tool having an associated bounding area smaller than the productivity document bounding area. Furthermore, the method may include receiving a user input within the bounding area of the joystick tool, determining a document navigational operation based on the user input, and adjusting a viewable portion of the productivity document from a first viewable portion to a second viewable portion based on the document navigational operation. The second viewable portion of the productivity document may differ from the first viewable portion.

### BACKGROUND

The present disclosure relates generally to graphical user interfaces and, more particularly, to an interface tool that may be utilized to navigate through content displayed on electronic devices.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Applications executed on electronic devices may include applications that enable users to input and edit text. Examples of such applications include word processing applications, presentation applications, spreadsheet applications, and note-taking applications. In some cases, a display of an electronic device may not display an entire document within an application. In other words, only a portion of a document within an application may be displayed. For example, in some cases, an electronic device may have a relatively small display and/or the document may be relatively large (e.g., wide, long, or both). Navigating through the document may prove challenging in such cases or with certain types of electronic devices.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The present disclosure relates to a virtual joystick tool that may be utilized to navigate through a productivity document (e.g., a text document, spreadsheet document, presentation document, etc.). More specifically, the joystick tool may be presented on a display of an electronic device with the productivity document, and a user of the electronic device may interact with the joystick tool to navigate within the productivity document. For instance, the joystick tool may include a joystick that the user may interact with to cause a viewable portion of the productivity document that is displayed to transition to another viewable portion of the productivity document. Additionally, a user may select within a bounding area associated with the joystick tool to cause the viewable portion of the productivity document to jump to another viewable portion of the productivity document. Accordingly, a user may be able to navigate through the productivity document in a convenient and intuitive manner, especially on electronic devices with relatively small displays and/or electronic devices that do not utilize input structures typically associated with computers, such as keyboards, mice, and/or trackpads.

Various refinements of the features noted above may be made in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a schematic block diagram of an electronic device that provides linked text boxes, according to embodiments of the present disclosure;

FIG. 2 is a perspective view of a notebook computer representing an embodiment of the electronic device of FIG. 1;

FIG. 3 is a front view of a hand-held device representing another embodiment of the electronic device of FIG. 1;

FIG. 4 is a front view of another hand-held device representing another embodiment of the electronic device of FIG. 1;

FIG. 5 is a front view of a desktop computer representing another embodiment of the electronic device of FIG. 1;

FIG. 6 is a front view and side view of a wearable electronic device representing another embodiment of the electronic device of FIG. 1;

FIG. 7 is a flow diagram for a process for adjusting a viewable portion of a productivity document, according to embodiments of the present disclosure;

FIG. 8 illustrates a software application program that may execute a productivity document, according to embodiments of the present disclosure;

FIG. 9 illustrates the software application program of FIG. 8 with a joystick tool, according to embodiments of the present disclosure;

FIGS. 10-16 illustrates the software application program of FIG. 8 when a viewable portion of a productivity document is modified based on a user interaction with the joystick tool of FIG. 9, according to embodiments of the present disclosure;

FIG. 17 illustrates the software application program of FIG. 8 when navigation through the productivity document can only occur leftwards or rightwards, according to embodiments of the present disclosure;

FIG. 18 illustrates the software application program of FIG. 8 when navigation through the productivity document can only occur upwards or downwards, according to embodiments of the present disclosure;

FIG. 19 is a flow diagram of a process for adjust a viewable portion of a productivity document by jumping, according to embodiments of the present disclosure;

FIG. 20 illustrates the software application program of FIG. 8 when a user makes an input to jump to a portion of a productivity document, according to embodiments of the present disclosure;

FIG. 21 illustrates the software application program and productivity document of FIG. 20 after adjusting a viewable portion of the productivity document based on a user input to jump to a portion of the productivity document, according to embodiments of the present disclosure;

FIG. 22 is a flow diagram of a process for adjusting a viewable portion of a productivity document, according to embodiments of the present disclosure;

FIG. 23 illustrates a user interaction with a central region of a bounding area of a joystick tool, according to embodiments of the present disclosure; and

FIG. 24 illustrates the productivity document and software application program of FIG. 23 after adjusting a viewable portion of the productivity document, according to embodiments of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “including” and “having” are intended to be inclusive and mean that there may be additional elements other than the listed elements. Additionally, it should be understood that references to “some embodiments,” “embodiments,” “one embodiment,” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

The present disclosure relates to a joystick tool that may be utilized to navigate through a productivity document (e.g., a text document, spreadsheet document, presentation document, etc.). More specifically, the joystick tool may be presented on a display of an electronic device with the productivity document, and a user of the electronic device may interact with the joystick tool to navigate within the productivity document. For instance, the joystick tool may include a joystick that the user may interact with to cause a viewable portion of the productivity document that is displayed to transition to another viewable portion of the productivity document. Additionally, a user may select within a bounding area associated with the joystick tool to cause the viewable portion of the productivity document to jump to another viewable portion of the productivity document. Accordingly, a user may be able to navigate through the productivity document in a convenient and intuitive manner, especially on electronic devices with relatively small displays and/or electronic devices that do not utilize input structures typically associated with computers, such as keyboards, mice, and/or trackpads.

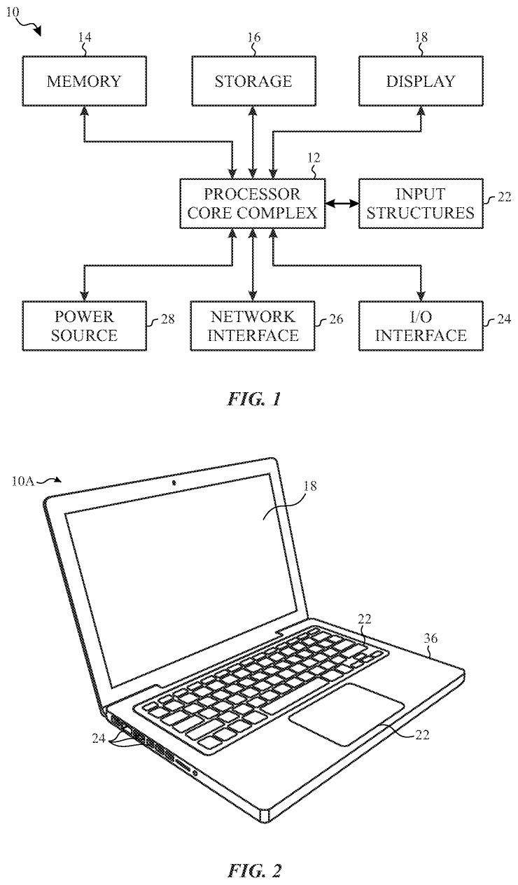

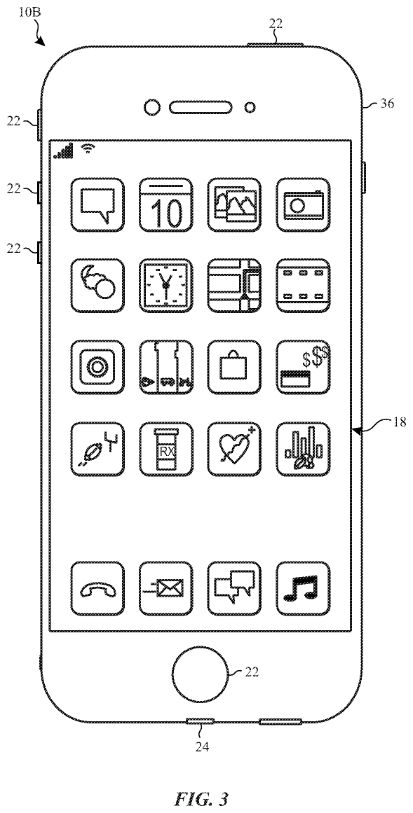

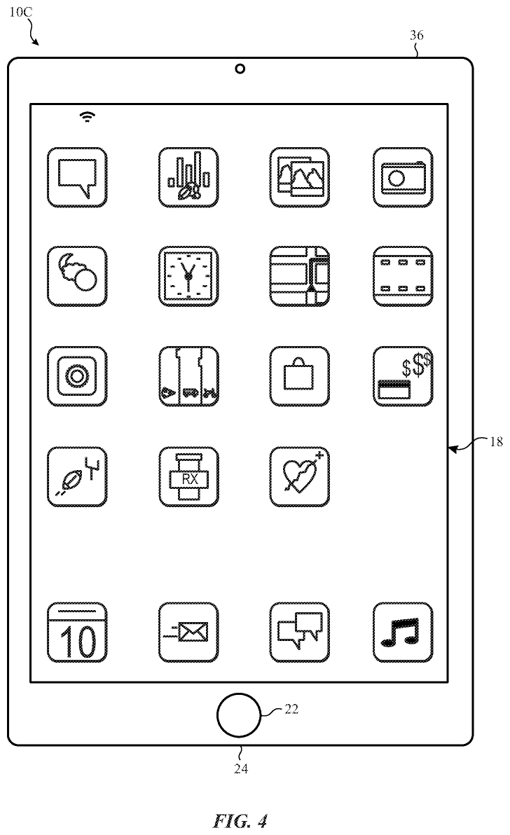

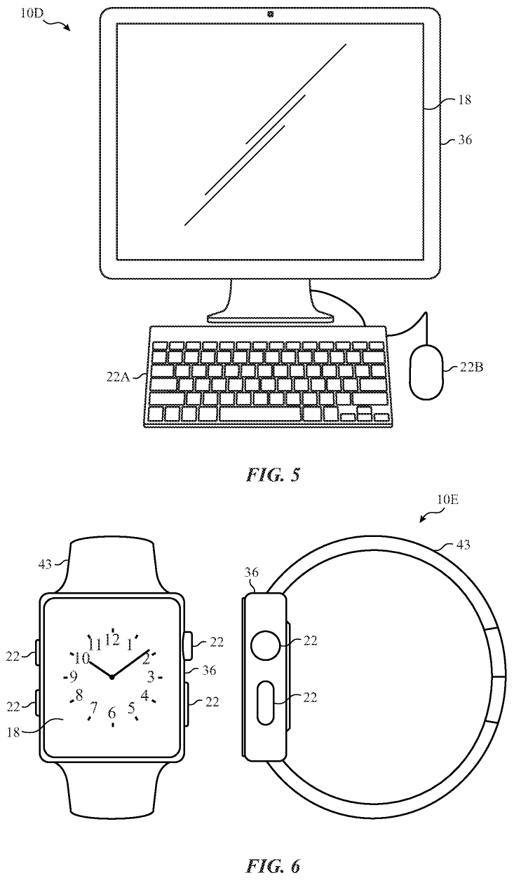

With this in mind, a block diagram of an electronic device 10 is shown in FIG. 1. As will be described in more detail below, the electronic device 10 may represent any suitable electronic device, such as a computer, a mobile phone, a portable media device, a tablet, a television, a virtual-reality headset, a vehicle dashboard, or the like. The electronic device 10 may represent, for example, a notebook computer 10A as depicted in FIG. 2, a handheld device 10B as depicted in FIG. 3, a handheld device 10C as depicted in FIG. 4, a desktop computer 10D as depicted in FIG. 5, a wearable electronic device 10E as depicted in FIG. 6, or a similar device.

The electronic device 10 shown in FIG. 1 may include, for example, a processor core complex 12, a local memory 14, a main memory storage device 16, an electronic display 18, input structures 22, an input/output (I/O) interface 24, a network interface 26, and a power source 28. The various functional blocks shown in FIG. 1 may include hardware elements (including circuitry), software elements (including machine-executable instructions stored on a tangible, non-transitory medium, such as the local memory 14 or the main memory storage device 16) or a combination of both hardware and software elements. It should be noted that FIG. 1 is merely one example of a particular implementation and is intended to illustrate the types of components that may be present in electronic device 10. Indeed, the various depicted components may be combined into fewer components or separated into additional components. For example, the local memory 14 and the main memory storage device 16 may be included in a single component.

The processor core complex 12 may carry out a variety of operations of the electronic device 10. The processor core complex 12 may include any suitable data processing circuitry to perform these operations, such as one or more microprocessors, one or more application program specific processors (ASICs), or one or more programmable logic devices (PLDs). In some cases, the processor core complex 12 may execute programs or instructions (e.g., an operating system or application program) stored on a suitable article of manufacture, such as the local memory 14 and/or the main memory storage device 16. For example, the processor core complex 12 may carry out instructions stored in the local memory 14 and/or the main memory storage device 16 to change a viewable portion of a document within an application based on user input. In addition to instructions for the processor core complex 12, the local memory 14 and/or the main memory storage device 16 may also store data to be processed by the processor core complex 12. By way of example, the local memory 14 may include random access memory (RAM) and the main memory storage device 16 may include read only memory (ROM), rewritable non-volatile memory such as flash memory, hard drives, optical discs, or the like.

The electronic display 18 may display image frames, such as a graphical user interface (GUI) for an operating system or an application program interface, still images, or video content. The processor core complex 12 may supply at least some of the image frames. For example, the processor core complex 12 may supply image frames that display an application and the joystick tool of this disclosure. The electronic display 18 may be a self-emissive display, such as an organic light emitting diodes (OLED) display, a micro-LED display, a micro-OLED type display, or a liquid crystal display (LCD) illuminated by a backlight. In some embodiments, the electronic display 18 may include a touch screen, which may allow users to interact with a user interface of the electronic device 10.

The input structures 22 of the electronic device 10 may enable a user to interact with the electronic device 10 (e.g., pressing a button to increase or decrease a volume level). The I/O interface 24 may enable electronic device 10 to interface with various other electronic devices, as may the network interface 26. The network interface 26 may include, for example, interfaces for a personal area network (PAN), such as a Bluetooth network, for a local area network (LAN) or wireless local area network (WLAN), such as an 802.11x Wi-Fi network, and/or for a wide area network (WAN), such as a cellular network. The network interface 26 may also include interfaces for, for example, broadband fixed wireless access networks (WiMAX), mobile broadband Wireless networks (mobile WiMAX), asynchronous digital subscriber lines (e.g., ADSL, VDSL), digital video broadcasting-terrestrial (DVB-T) and its extension DVB Handheld (DVB-H), ultra wideband (UWB), alternating current (AC) power lines, and so forth. The power source 28 may include any suitable source of power, such as a rechargeable lithium polymer (Li-poly) battery and/or an alternating current (AC) power converter.

In certain embodiments, the electronic device 10 may take the form of a computer, a portable electronic device, a wearable electronic device, or other type of electronic device. Such computers may include computers that are generally portable (such as laptop, notebook, and tablet computers) as well as computers that are generally used in one place (such as desktop computers, workstations and/or servers). In certain embodiments, the electronic device 10 in the form of a computer may be a model of a MacBook®, MacBook® Pro, MacBook Air®, iMac®, Mac® mini, or Mac Pro® available from Apple Inc. By way of example, the electronic device 10, taking the form of a notebook computer 10A, is illustrated in FIG. 2 according to embodiments of the present disclosure. The depicted computer 10A may include a housing or enclosure 36, an electronic display 18, input structures 22, and ports of an I/O interface 24. In one embodiment, the input structures 22 (such as a keyboard and/or touchpad) may be used to interact with the computer 10A, such as to start, control, or operate a GUI or application programs running on computer 10A. For example, a keyboard and/or touchpad may allow a user to navigate a user interface or application program interface displayed on the electronic display 18.

FIG. 3 depicts a front view of a handheld device 10B, which represents one embodiment of the electronic device 10. The handheld device 10B may represent, for example, a portable phone, a media player, a personal data organizer, a handheld game platform, or any combination of such devices. By way of example, the handheld device 10B may be a model of an iPod® or iPhone® available from Apple Inc. of Cupertino, Calif. The handheld device 10B may include an enclosure 36 to protect interior components from physical damage and to shield them from electromagnetic interference. The enclosure 36 may surround the electronic display 18. The I/O interfaces 24 may open through the enclosure 36 and may include, for example, an I/O port for a hard-wired connection for charging and/or content manipulation using a standard connector and protocol, such as the Lightning connector provided by Apple Inc., a universal service bus (USB), or other similar connector and protocol.

User input structures 22, in combination with the electronic display 18, may allow a user to control the handheld device 10B. For example, the input structures 22 may activate or deactivate the handheld device 10B, navigate user interface to a home screen, a user-configurable application program screen, and/or activate a voice-recognition feature of the handheld device 10B. Other input structures 22 may provide volume control, or may toggle between vibrate and ring modes. The input structures 22 may also include a microphone may obtain a user's voice for various voice-related features, and a speaker may enable audio playback and/or certain phone capabilities. The input structures 22 may also include a headphone input may provide a connection to external speakers and/or headphones.

FIG. 4 depicts a front view of another handheld device 10C, which represents another embodiment of the electronic device 10. The handheld device 10C may represent, for example, a tablet computer or portable computing device. By way of example, the handheld device 10C may be a tablet-sized embodiment of the electronic device 10, which may be, for example, a model of an iPad® available from Apple Inc. of Cupertino, Calif.

Turning to FIG. 5, a computer 10D may represent another embodiment of the electronic device 10 of FIG. 1. The computer 10D may be any computer, such as a desktop computer, a server, or a notebook computer, but may also be a standalone media player or video gaming machine. By way of example, the computer 10D may be an iMac®, a MacBook®, or other similar device by Apple Inc. It should be noted that the computer 10D may also represent a personal computer (PC) by another manufacturer. A similar enclosure 36 may be provided to protect and enclose internal components of the computer 10D such as the electronic display 18. In certain embodiments, a user of the computer 10D may interact with the computer 10D using various peripheral input devices, such as input structures 22A or 22B (e.g., keyboard and mouse), which may connect to the computer 10D.

Similarly, FIG. 6 depicts a wearable electronic device 10E representing another embodiment of the electronic device 10 of FIG. 1 that may be configured to operate using the techniques described herein. By way of example, the wearable electronic device 10E, which may include a wristband 43, may be an Apple Watch® by Apple, Inc. However, in other embodiments, the wearable electronic device 10E may include any wearable electronic device such as, for example, a wearable exercise monitoring device (e.g., pedometer, accelerometer, heart rate monitor) or other device by another manufacturer. The electronic display 18 of the wearable electronic device 10E may include a touch screen display 18 (e.g., LCD, OLED display, active-matrix organic light emitting diode (AMOLED) display, and so forth), as well as input structures 22, which may allow users to interact with a user interface of the wearable electronic device 10E.

As noted above, the present disclosure relates to a joystick tool that may be used to navigate within an application that may be displayed on a display of an electronic device, such as the electronic display 18 of the electronic device 10. For example, as discussed below, a user may interact with the joystick tool (e.g., via a touch screen display or the input structures 22), and a viewable portion of a document within an application may be changed based on the user's interaction with the joystick tool.

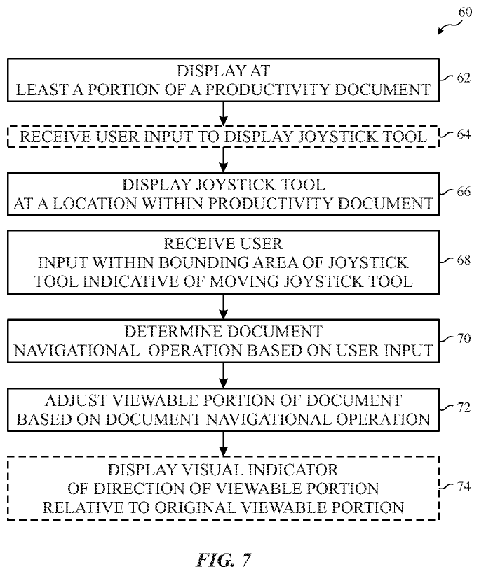

With the foregoing in mind, FIG. 7 is a flow diagram of a process 60 for adjusting a viewable portion of a productivity document. The process 60 may be implemented in the form of an application program that includes instructions that are executed by at least one suitable processor of a computer system, such as the processor core complex 12 of the electronic device 10. The illustrated process 60 is merely provided as an example, and in other embodiments, certain illustrated steps of the process 60 may be performed in other orders, skipped, or repeated, according to embodiments of the present disclosure. As discussed below, the process 60 generally includes displaying at least a portion of a productivity document (e.g., process block 62), receiving user input to display a joystick tool (e.g., process block 64), displaying the joystick tool (process block 66), receiving user input within a bounding area of the joystick tool (e.g., process block 68), determining a document navigational operation based on the user input (e.g., process block 70), adjusting a viewable portion of the document based on the document navigational operation (e.g., process block 72), and displaying a visual indicator of a direction of the viewable portion of the document relative to an original viewable portion of the document (e.g., process block 74).

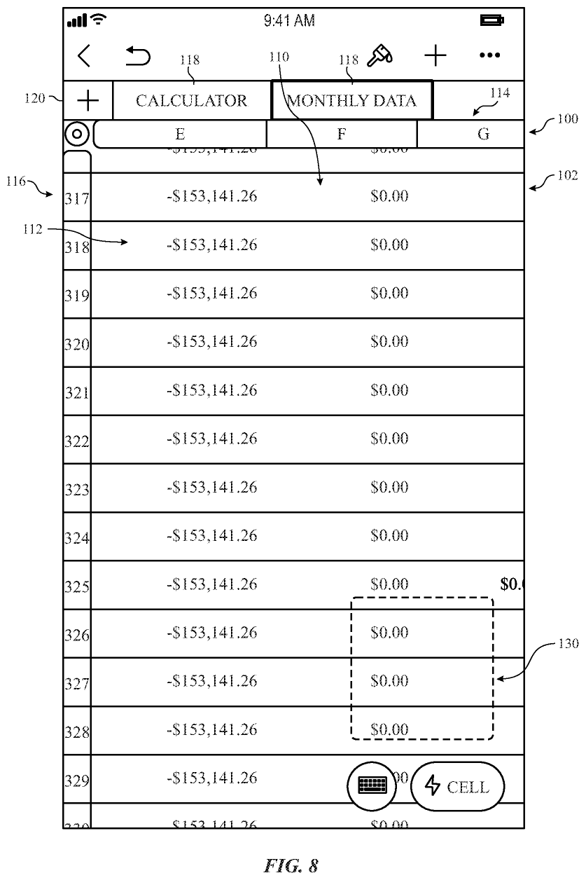

At process block 62, the processor core complex 12 may display at least a portion of a productivity document. To help elaborate, FIG. 8 illustrates a software application program 100. In the illustrated embodiment, the software application program 100 provides a productivity document 102, which more specifically, in the current embodiment, is a spreadsheet document. However, the software application program 100 may be any suitable software application program that may generate and/or provide productivity documents, such as text documents (e.g., from a word processing application), presentation documents, and notes (e.g., from a note-taking application).

The productivity document 102 includes columns 110 and rows 112 of data. Additionally, the software application program 100 may include a column indicator 114 and a row indicator 116, which respectively indicate which column and row a particular datum (e.g., a cell within the spreadsheet) is included in. In some cases, the software application program 100 may also include tabs 118 that enable users to switch between different portions of the productivity document 102 within the software application program 100. For example, in the illustrated embodiment, the tabs 118 may be utilized to switch between two different spreadsheets within the productivity document 102. Additionally, the software application program 100 may include a new tab tool 120, which when selected by a user, may cause the processor core complex 12 to add a new tab (e.g., a new spreadsheet in a spreadsheet application) to the productivity document 102.

The productivity document 102 may have a bounding area, such as an area of the electronic display 18 or a portion of the electronic display 18. In some instances, the productivity document 102 provided by the software application program 100 may be larger display 18 of the electronic device 10 upon which the software application program 100 is displayed. In other words, a portion of the productivity document 102 may be displayed (e.g., a viewable portion) via the electronic display 18 while other portions of the productivity document 102 are not displayed. For example, in a spreadsheet document, there may be rows and/or columns of data that may not be displayed on the electronic display 18. In some cases, portions of the productivity document 102 may not be displayed due to a viewing perspective (e.g., zoom level), a size of the electronic display 18, the amount of data in the productivity document 102, or a combination thereof. For example, in embodiments in which the electronic device 10 is the handheld device 10B, handheld device 10C, and wearable electronic device 10E, the viewable portion of the productivity document 102 may be smaller than a viewable portion of the same document when displayed by an electronic device that may have a relatively larger display 18, such as the computer 10A or the computer 10D.

A user may navigate through the productivity document 102 to change which portion of the productivity document 102 is being displayed. For example, when the input structures 22 include a keyboard and/or mouse, a user may utilize the keyboard and/or mouse to navigate through the productivity document 102. Additionally, the input structures 22 may include the electronic display 18 in embodiments of the electronic device 10 in which the electronic display 18 is a touch screen. For instance, a user may drag a finger or stylus along the electronic display 18 to move the viewable portion of the productivity document 102 from one viewable portion to another.

As mentioned above, the software application program 100 may include a joystick tool that is defined by a bounding area 130. That is, the joystick tool may be a user interface feature provided within a portion of the bounding area of the productivity document 102. In other embodiments, the bounding area 130 may be larger than the bounding area associated with the productivity document 102 (e.g., when the productivity document 102 utilizes a relatively small portion of the electronic display 18). As will be discussed below, a user may interact with the joystick tool to navigate through the productivity document 102. It should be noted that when the joystick tool is not being displayed, the bounding area 130 may be transparent or not displayed. In other embodiments, the bounding area 130 may be slightly opaque, which may enable users to see where the bounding area 130 is within the software application program 100.

Returning to FIG. 7, at process block 64, the processor core complex 12 may receive user input to display a joystick tool. For example, a user may utilize the input structures 22 or the electronic display 18 in embodiments in which the electronic display 18 is a touch screen to interact with a user interface displayed on the electronic display 18 to cause the joystick tool to be displayed. More specifically, a user may select an area within the bounding area 130, and in response, the processor core complex 12 may cause the joystick tool to be displayed.

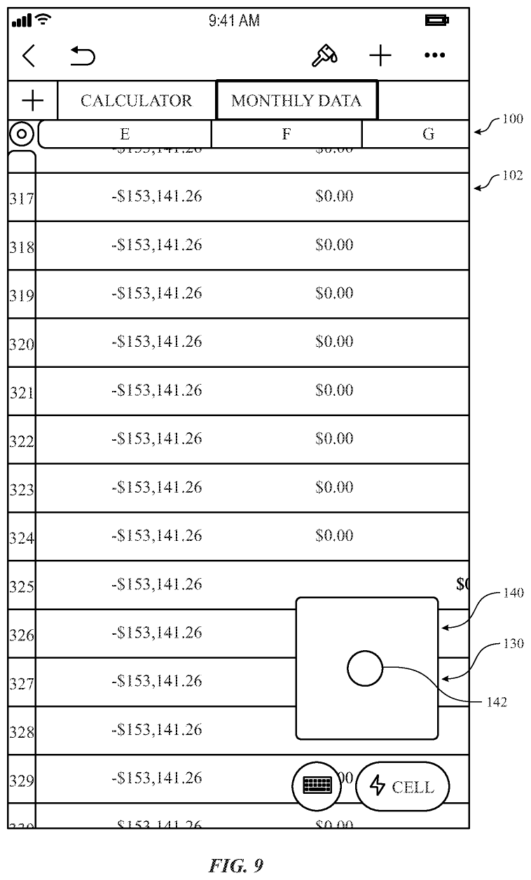

At process block 66, the processor core complex 12 may display the joystick tool at a location within the productivity document 102 (and software application program 100) in response to receiving the user input to display the joystick tool. To help illustrate, FIG. 9 illustrates an embodiment of the software application program 100 in which a joystick tool 140 is displayed. As described above, the joystick tool 140 may be included within the bounding area 130 within the software application program 100 and/or productivity document 102. The joystick tool 140 may presented as a head-up display (HUD) that appears transparent or partially transparent over the productivity document 102 when displayed. Moreover, when the joystick tool 140 is displayed, the bounding area 130 may be presented via the electronic display 18 more opaquely than when the joystick tool 140 is not displayed. Additionally, a joystick 142 of the joystick tool 140 may also be displayed. The joystick 142 may be presented in the middle or near the center of the bounding area. As discussed below, a user may interact with the joystick 142 as well as with different portions within the bounding area 130 to adjust a movable portion of the productivity document 102 from one viewable portion to another. Furthermore, it should also be noted that, in some embodiment, the joystick 142 may be representative of a portion of the bounded area 130 with which a user is interacting. In other words, while the discussion below includes examples of a user moving the joystick 142, in some embodiments, the examples may be representative of movements made by a user (e.g., with a finger or stylus) within the bounding area 130, and the joystick 142 may not be presented to the user.

Additionally, it should be noted that in some embodiments, the joystick tool 140 may be provided without receiving user input to display the joystick tool 140. For example, the joystick tool 140 may be provided upon startup of the software application program 100 or loading or creation of the productivity document 102. As another example, the joystick tool 140 may be provided when a user navigates within the productivity document 102 via a manner other than utilizing the joystick tool 140.

Referring back to FIG. 7, at process block 68, the processor core complex 12 may receive user input within the bounding area 130 of the joystick tool 140. For example, the user may utilize the input structures 22 or, in embodiments in which the electronic display 18 is a touch screen display, the electronic display 18 to interact with the joystick 142 or select within the bounding area 130 (e.g., a space within the bounding area 130 not occupied by the joystick 142). For instance, a user may move the joystick 142 by dragging the joystick 142 (e.g., using a finger or stylus on a touch screen display 18 or via the input structures 22) from one position within the bounding area 130 to another position within the bounding area 130. As another example, a user may select a space within the bounding area 130 other than the joystick 142 by selecting the space via a touch screen display 18 or using the input structures 22. More particularly, in embodiments in which the electronic display 18 is a touch screen display, the processor core complex 12 may discern different types of interactions a user has with the electronic display 18. For example, the processor core complex 12 may discern a number of times a user touches the electronic display 18 (e.g., a single tap or double tap), a duration that a user interacts with the display (e.g., a short press or a long press), and an amount of pressure that a user applies to the electronic display 18 (e.g., a light press or a hard press).

In response to receiving user input within the bounding area of the joystick tool 140, at process block 70, the processor core complex 12 may determine a document navigational operation. The document navigational operation may be an operation that, when performed, causes a viewable portion of the productivity document 102 to change to another viewable portion of the productivity document 102. In particular, the processor core complex 12 may determine the document navigational operation based on the type of interaction the user has with the joystick tool 140. For example, when the user input is indicative of the user interacting with the joystick 142, the document navigational operation may be a vector that indicates a magnitude and direction that respectively correspond to a distance the user has moved the joystick 142 (e.g., a distance from a starting position of the joystick 142, such as the middle of the bounding area 130) and a direction the user has moved the joystick 142 (e.g., a direction relative to a starting position of the joystick 142). For example, the farther the user moves the joystick 142 from one portion of the bounding area 130 (e.g., a center point of the bounding area 130), the greater the magnitude.

Regarding the direction indicated by the user input, in some embodiments, the processor core complex 12 may determine the user input as corresponding to one of several specific directions, such as up, down, left, or right, or a combination thereof (e.g., up and left, up and right, down and left, down and right). More specifically, when the direction indicated by the user input corresponds to a combination of directions, the direction determined by the processor core complex 12 may be similar to compass directions (e.g., up and right at a forty-five degree angle corresponding to northeast, up and right at a thirty degree angle corresponding to east-northeast, etc.). In other words, the processor core complex 12 may determine an angle relative to a position (e.g., a center point of the bounding area 130 or a previous position of the joystick 142), and the transition from one viewable portion of the productivity document 102 to another viewable portion of the productivity document 102 may correspond to a different but similar angle. For example, if the processor core complex 12 determines that the angle indicated by the user input is a first angle, the processor core complex 12 may determine a predefined angle that is most similar to the first angle, and the transition from one viewable portion to another viewable portion may correspond to the predefined angle that is similar to the first angle.

As another example of determining a document navigational operation, when the user input is indicative of the user having selected a portion of the bounding area 130 other than the joystick 142, the processor core complex 12 may similarly determine a vector that indicates a magnitude and direction, or the processor core complex 12 may determine a jump position to which a “jump” will occur. For example, as discussed below, when a user interacts with some portions of the bounding area 130, the processor core complex 12 may cause a first viewable portion of the productivity document 102 to move to a second viewable portion of the productivity document 102 without displaying portions of the productivity document 102 that are between the first and second viewable portions.

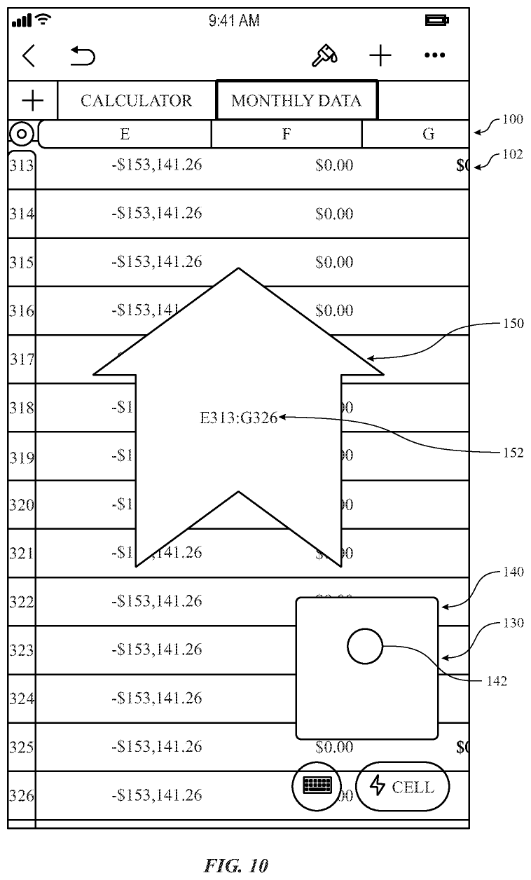

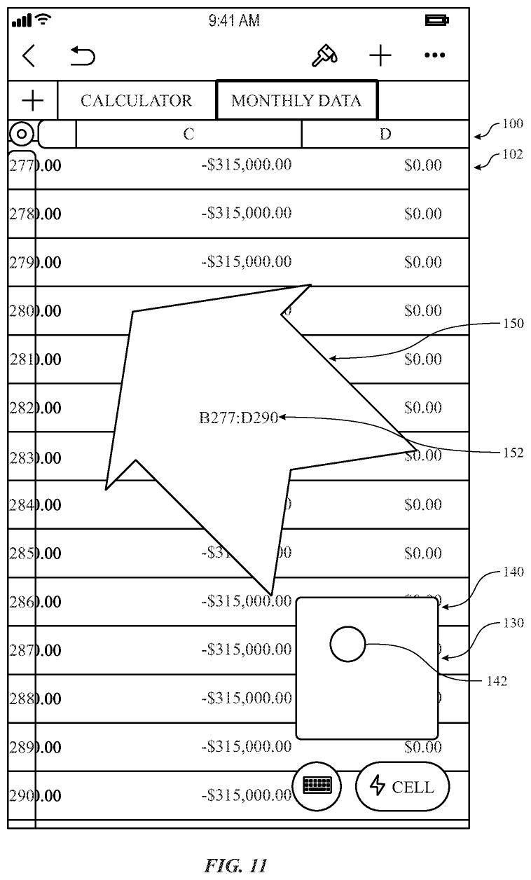

At process block 72, the processor core complex 12 may adjust a viewable portion of the productivity document 102 based on the document navigational operation. To help illustrate, FIG. 10 shows the software application program 100 when a viewable portion of the productivity document 102 is changed to another viewable portion of the productivity document 102. More specifically, the viewable portion of the productivity document 102 is adjusted based on a user input to move the joystick 142 from a starting position within the bounding area 130 (e.g., the position of the joystick 142 in FIG. 9) to the position of the joystick 142 shown in FIG. 10. As illustrated, relative to FIG. 9, the joystick 142 has been moved upwards. Accordingly, the viewable portion of the productivity document 102 is shifted upwards. For example, the viewable portion may gradually shift upwards as the user maintains the position of the joystick 142 shown in FIG. 10. In other words, the electronic display 18 may show the transition from one viewable portion to another viewable portion.

Returning to the discussion of the process 60 in FIG. 7, at process block 74, the processor core complex 12 may display a visual indicator of a direction of the viewable portion relative to an original viewable portion. In particular, the visual indicator may be shown during the transitions from one viewable portion to another. For example, as illustrated in FIG. 10, a visual indicator 150 is displayed. The visual indicator 150 indicates the direction of navigation through the productivity document 102 (e.g., upwards). Moreover, the visual indicator 150 may include a viewable portion indicator 152 that may indicate which portion of the productivity document 102 is currently being displayed via the electronic display 18. For instance, in FIG. 10, the viewable portion indicator 152 indicates which columns 110 and row 112 of the productivity document 102 are included in the viewable portion. More specifically, the viewable portion indicator 152 indicates a cell that that is in the top-left corner of the viewable portion and a cell that is in the bottom-right corner of the viewable portion.

In some embodiments, the visual indicator 150 may also indicate how quickly the viewable portion is changing (e.g., transitioning from one viewable portion of the productivity document 102 to another viewable portion). In other words, the visual indicator 150 may be indicator of how far the user has moved the joystick 142 from the center of the bounding area 130 as well as the magnitude of the vector of the document navigational operation. For example, the size of the visual indicator may be larger the farther the joystick 142 has been moved from the center of the bounding area 130. As another example, the visual indicator 150 may be displayed with varying levels of transparency (or opacity) based on how far the joystick 142 has been moved from the center of the bounding area 130. For instance, the visual indicator 150 may become darker the farther the joystick 142 is moved from the center of the bounding area 130.

Portions of the process 60 may be repeated while a user interacts with the software application program 100 or the productivity document 102. For example, the processor core complex 12 may receive multiple user inputs within the bounding area 130 during a user's experience with the productivity document 102. For instance, the user may move the joystick 142 from one position to another position. In response, the processor core complex 12 may determine a document navigational operation based on the input, adjust a viewable portion of the productivity document 102 based on the document navigational operation, and display the visual indicator 150 to indicate a direction of the viewable portion of the productivity document 102 being displayed relative to an original (or previous) viewable portion of the productivity document 102.

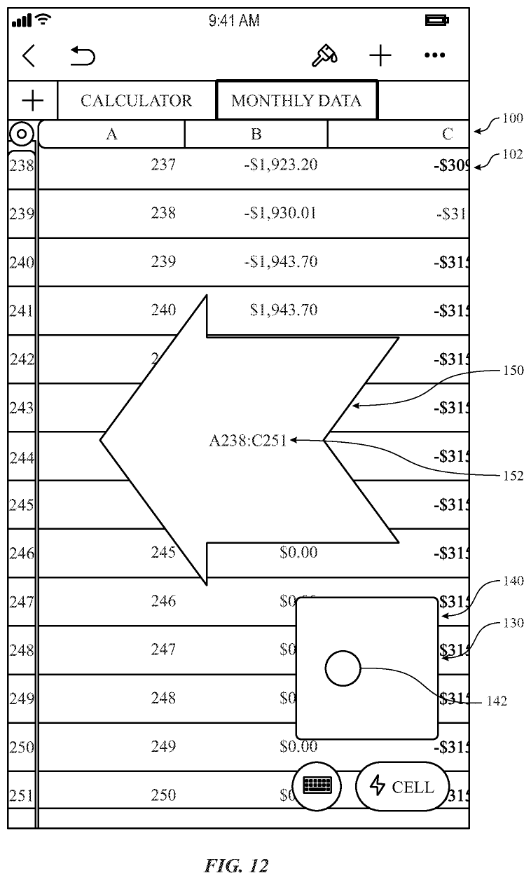

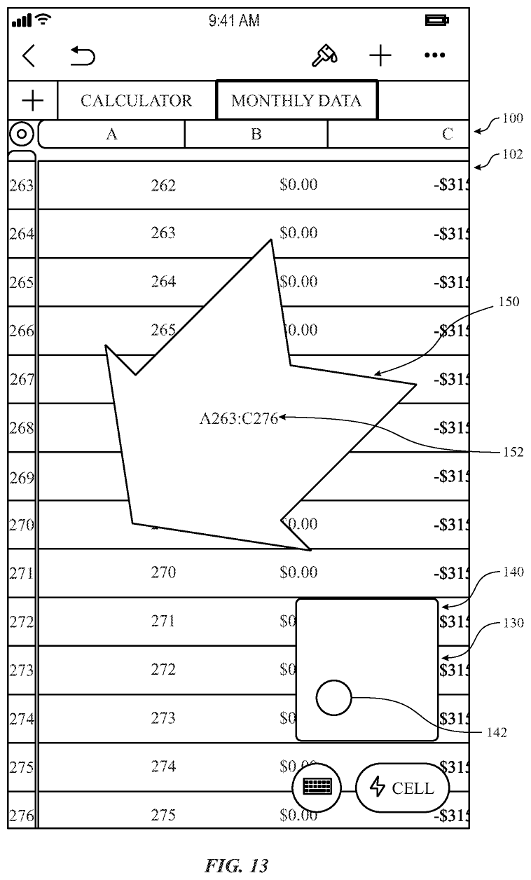

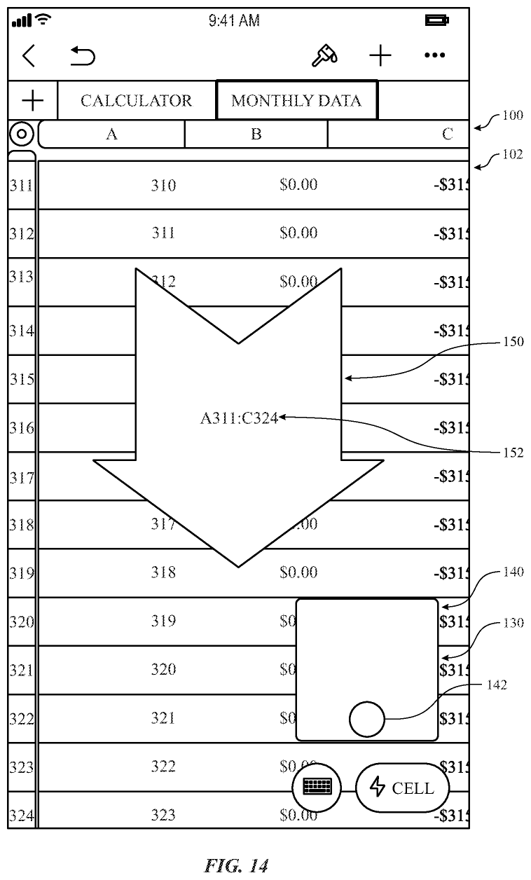

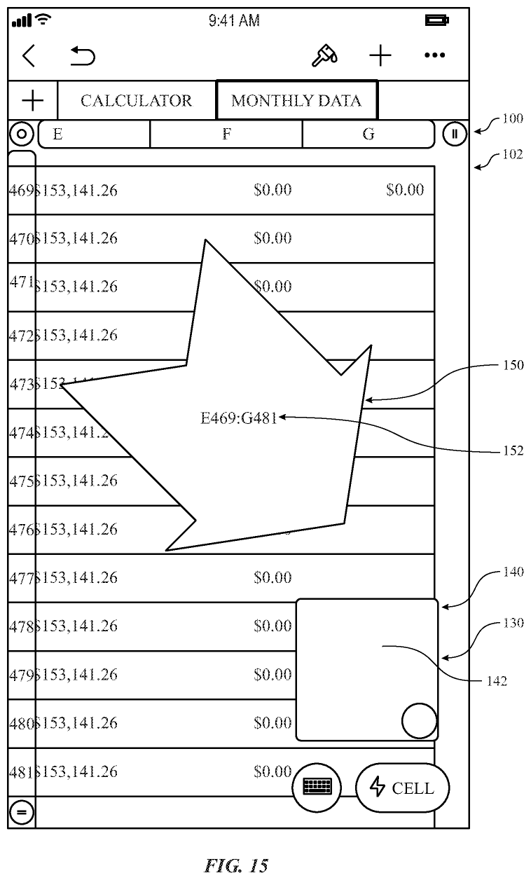

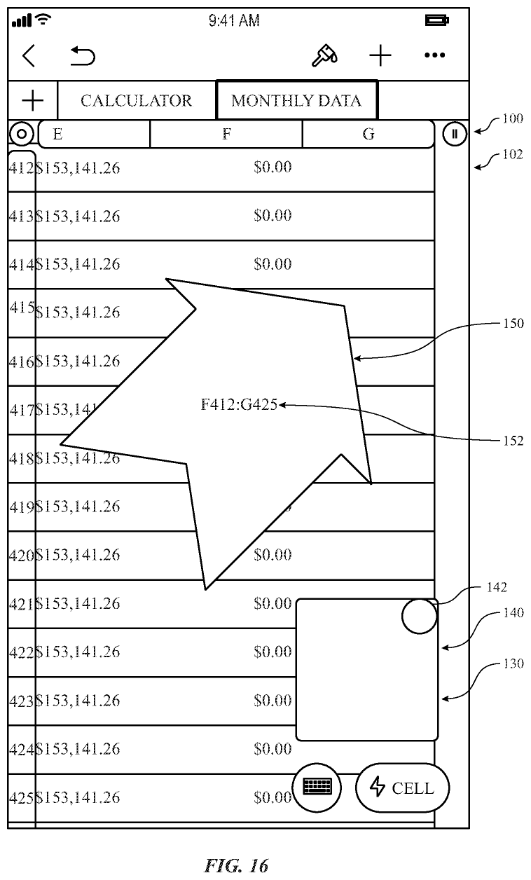

For example, FIGS. 11-16 each illustrate the software application program 100 while a user is interacting with the joystick tool 140. More specifically, as the user moves the joystick 142 within the bounding area 130, the viewable portion of the productivity document 102 that is displayed is adjusted based on the user interaction with the joystick 142. For instance, in FIG. 11, when the user moves the joystick 142 to a top-leftward position of the bounding area 130, the processor core complex 12 adjusts the viewable portion of the productivity document 102 by navigating upward and leftward within the productivity document 102. As another example, as illustrated in FIG. 12, when the user moves the joystick 142 to a leftward position of the bounding area 130, the processor core complex 12 adjusts the viewable portion of the productivity document 102 by navigating leftward within the productivity document 102. As yet another example, as shown in FIG. 13, when the user moves the joystick 142 to a bottom-leftward position of the bounding area 130, the processor core complex 12 adjusts the viewable portion of the productivity document 102 by navigating downward and leftward within the productivity document 102. Similarly, as illustrated in FIG. 14, when the user moves the joystick 142 to a bottom position of the bounding area 130, the processor core complex 12 adjusts the viewable portion of the productivity document 102 by navigating downward within the productivity document 102. As another example, as shown in FIG. 15, when the user moves the joystick 142 to a bottom-right position of the bounding area 130, the processor core complex 12 adjusts the viewable portion of the productivity document 102 by navigating downward and rightward within the productivity document 102. And, as yet another example, as illustrated in FIG. 16, when the user moves the joystick 142 to a top-right position of the bounding area 130, the processor core complex 12 adjusts the viewable portion of the productivity document 102 by navigating upward and rightward within the productivity document 102.

In other embodiments, the process 60 may include additional operations. For example, the processor core complex 12 may determine characteristics of the productivity document 102 such as the number of pages, columns 110, rows 112, and/or slides, which can depend on the type of document the productivity document 102 is (e.g., spreadsheet document, presentation document, text document). The characteristics may also relate to a portion of the productivity document 102 that is populated with user-created data (e.g., text data, image data, etc.). For instance, the processor core complex 12 may determine which portion of the productivity document 102 include user-created data. The processor core complex 12 may also determine settings of the software application program 100 such as a perspective or zoom level. Based on the characteristics of the productivity document 102 and settings of the software application program 100, the processor core complex 12 may determine one or more directions that a user can navigate within the productivity document 102 and indicate the directions with the joystick tool 140. For instance, the processor core complex 12 may determine that navigation may only occur leftwards or downwards within the productivity document 102 in some cases, while in other cases, the processor core complex 12 may determine that navigation can only occur upwards or downwards.

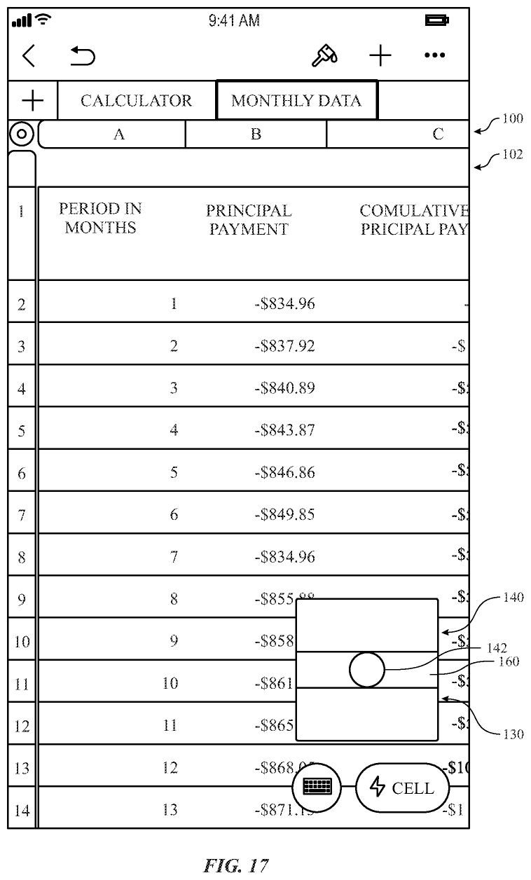

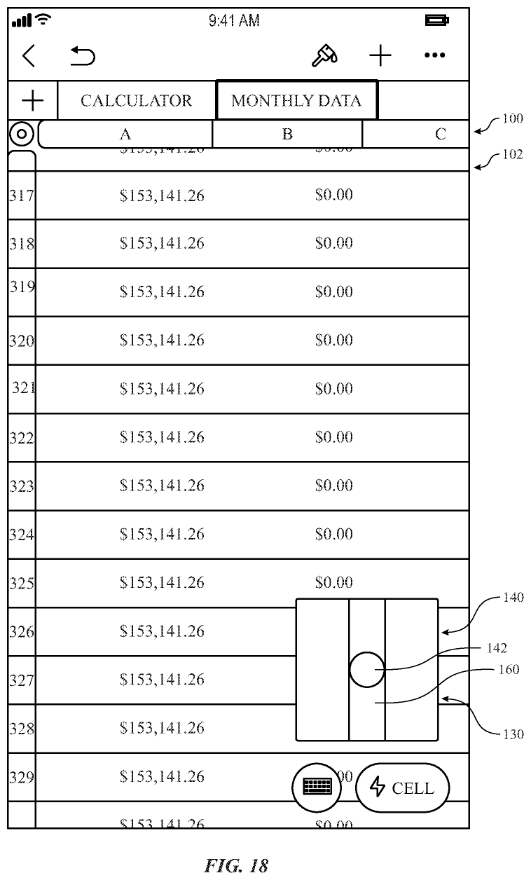

To help illustrate, FIG. 17 shows the software application program 100 when the processor core complex 12 has determined that navigation through the productivity document can only occur leftwards or rightwards. As illustrated, a region 160 within the bounding area 130 may be displayed. The user may only be able to move the joystick 142 to, or indicate a portion of, the bounding area 130 that is inside of the region 160. Similarly, additionally, FIG. 18 shows the software application program 100 when the processor core complex 12 has determined that navigation through the productivity document can only occur upwards or downwards. Additionally, it should be noted that while FIG. 17 and FIG. 18 respectively indicate examples of when the navigation throughout the productivity document 102 may only occur horizontally or vertically, in other embodiments, the processor core complex 12 may determine that navigation can occur in fewer than two directions or in more than two directions (and the region 160 may be presented based on the determined direction(s)). Additionally, it should be noted that the processor core complex 12 may determine that navigation within the productivity document 102 may occur based on the productivity document 102 itself (e.g., dimensions such as a height or width of the productivity document 102) or based on user-created content within the productivity document 102. For example, in a spreadsheet document, there may be columns or rows of cells that are unpopulated (e.g., do not include user-created data), and the processor core-complex may determine that navigation through the productivity document 102 is limited to the populated portions (e.g., portions of the productivity document 102 that include user- created data) of the productivity document 102.

Moreover, it should be noted that the region 160 may be displayed with a different opacity than the portions within the bounding area 130 that are not included within the region 160. For example, in some embodiments, the portions of the bounding area 130 that are not included in the region 160 may be relatively more transparent than the region 160. As another example, in some embodiments, the portions within the bounding area 130 that are located outside of the region 160 may be completely transparent or not displayed. In such embodiments, only the portions of the joystick tool 140 located within the region 160 may be displayed. In other words, the region 160 may be presented as, or instead of, the bounding area 130 of the joystick tool 140.

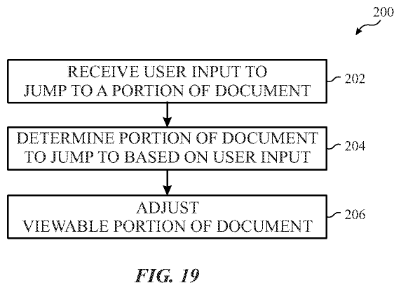

As described above, user inputs made with the joystick tool 140 may not utilize the joystick 142. For example, the joystick tool 140 may be utilized to jump within the productivity document when a user interacts within the bounding area 130 but not with the joystick 142. With this in mind, FIG. 19 is a flow diagram of a process 200 for adjusting a viewable portion of the productivity document 102. More specifically, the process 200 is a process for jumping within the productivity document 102. The process 200 may be implemented in the form of an application program (e.g., the software application program 100) that includes instructions that are executed by at least one suitable processor of a computer system, such as the processor core complex 12 of the electronic device 10. The illustrated process 200 is merely provided as an example, and in other embodiments, certain illustrated steps of the process 200 may be performed in other orders, skipped, or repeated, according to embodiments of the present disclosure. Moreover, the process 200 or portions thereof may be performed in conjunction with, or as part of, the process 60. The process 200 generally includes receiving user input to jump to a portion of the productivity document 102 (e.g., process block 202), determining a portion of the productivity document to jump to based on the user input (e.g., process block 204), and adjusting a viewable portion of the document (e.g., process block 206).

At process block 202, the processor core complex 12 may receive user input to jump to a portion of the productivity document 102. As discussed above, a user may select within the bounding area 130 (e.g., via the input structures 22 or the electronic display 18 when the electronic display 18 is a touch screen display) other than the joystick 142. For instance, a user may select a portion within the bounding area 130 that is relatively closer to the perimeter of the bounding area 130 relative to the joystick 142. Additionally, the specific user interaction with the joystick tool 140 may be in the form of a single tap, double tap, short press, long press, soft press, or hard press on the electronic display 18 in embodiments of the electronic device 10 in which the electronic display 18 is a touch screen display. Furthermore, the processor core complex 12 may discern any other input that is distinguishable from other types of inputs discussed above, such as moving the joystick 142 or making a dragging motion.

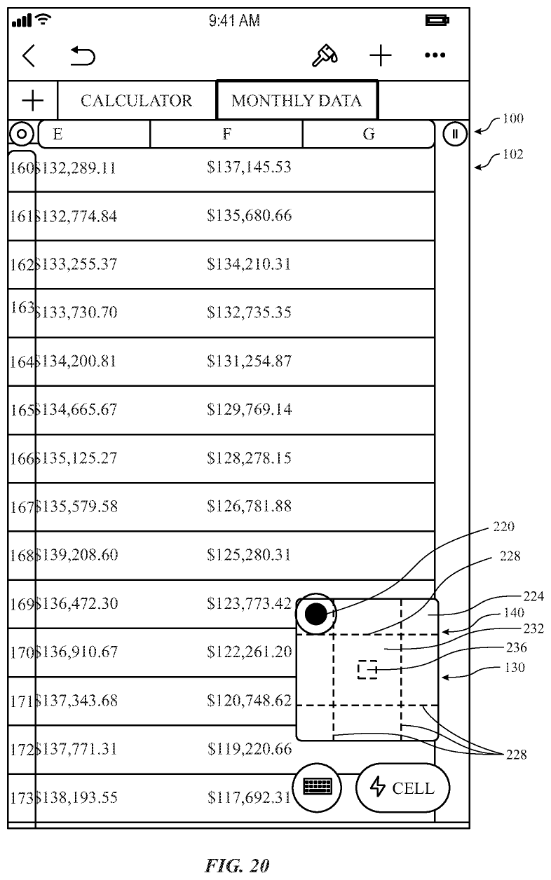

For instance, FIG. 20 illustrates the software application program 100 when a user makes an input 220 to jump to a portion of the productivity document 102. In particular, the input 220 is indicative of a user interacting with a top-left corner within the bounding area 130. For example, the input 220 may be representative of a user utilizing the input structures 22 to select the top-left corner or a user interaction with the top-left corner utilizing the display 18 in embodiments in which the electronic display 18 includes a touch screen display. For instance, the input 220 may be single tap, double tap, short press, long press, soft press, or hard press on the electronic display 18. The top-left corner may be included in a special region within the bounding area 130. In the illustrated embodiment, the special regions may include each of the eight regions (e.g., special region 224) defined by the lines 228 that form a perimeter around a central region 232. The special regions may also include a center region 236 that is located within the central region 232. Furthermore, it should be noted that the lines 228 may be presented via the electronic display 18 in some embodiments, while in other embodiments, the lines 228 may not be displayed. Similarly, in some embodiments, the center region 236 may be indicated via the electronic display 18, while in other embodiments, the center region 236 may not be visually indicated within the bounding area 230.

Returning to FIG. 19, at process block 204, the processor core complex 12 may determine a portion of the productivity document 102 to jump to based on the user input (e.g., input 220). For instance, referring to FIG. 20, each of the special regions may be associated with a corresponding portion of the productivity document 102. For example, the special region 224 may be correspond to a top-right corner of the productivity document 102. The center region 236 may correspond to a midpoint or center within the productivity document 102 or portion of the productivity document 102, such as a page, spreadsheet, or slide within the productivity document 102.

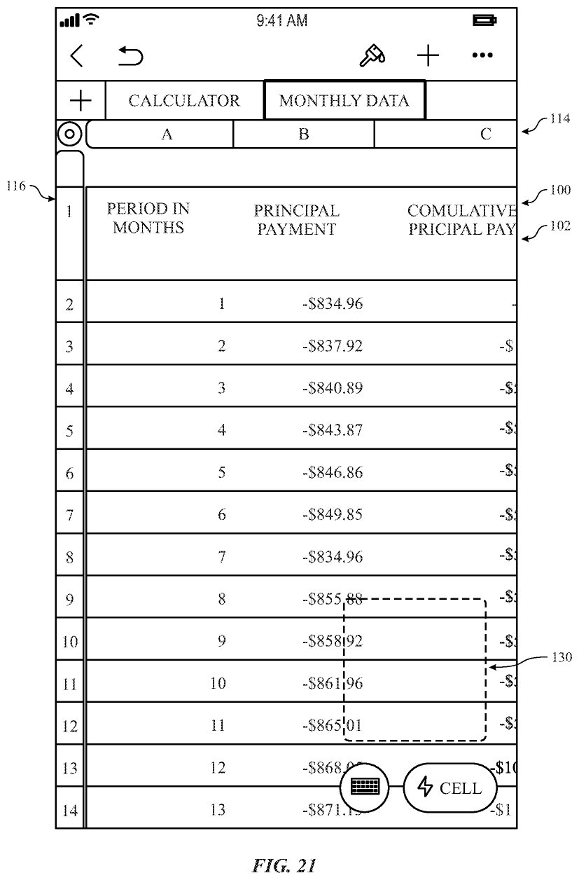

Referring back to FIG. 19, at process block 206, the processor core complex 12 may adjust a viewable portion of the productivity document 102. For instance, in response to receiving the input 220 of FIG. 20, a different viewable portion of the productivity document 102 may be presented via the electronic display 18. Continuing with the example of the input 220, FIG. 21 illustrates the software application program 100 after adjusting the viewable portion in response to the input 220 of FIG. 20. More specifically, as indicated by the column indicator 114 and row indicator 116, the viewable portion of the productivity document 102 that is displayed via the electronic display 18 is the top-left corner of the productivity document 102. In other words, in response to the user having selected the top-left corner or special region of the bounding area 130 (e.g., via the input 220), the processor core complex 12 determined that the input 220 corresponds to the top-left corner of the productivity document 102 and caused the top-left corner of the productivity document 102 to be displayed. In particular, the viewable portion of the productivity document 102 may be displayed via a “jump,” meaning that the viewable portion may being displayed may be replaced with a different viewable portion without showing a transition between the two viewable portions.

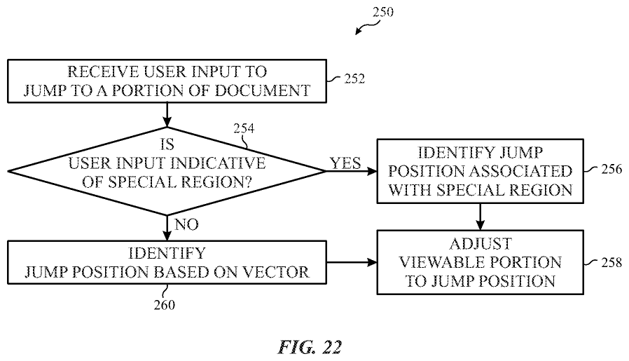

As discussed above, the user interaction or input within the bounding area 130 may be in a special region (e.g., special region 224 or center region 236) or in the central region 232. With this in mind, FIG. 22 is a flow diagram of a process 250 for adjusting a viewable portion of the productivity document 102. More specifically, the process 250 is an embodiment of the process 200 that includes determinations based on the type of user input received to determine how a jump will be performed. The process 250 may be implemented in the form of an application program (e.g., the software application program 100) that includes instructions that are executed by at least one suitable processor of a computer system, such as the processor core complex 12 of the electronic device 10. The illustrated process 250 is merely provided as an example, and in other embodiments, certain illustrated steps of the process 250 may be performed in other orders, skipped, or repeated, according to embodiments of the present disclosure. Moreover, the process 250 or portions thereof may be performed in concert with, or as part of, the process 60 and/or the process 200.

At process block 252, the processor core complex 12 may receive user input to jump to a portion of the productivity document 102. For instance, as discussed above, the user input may correspond to a user interaction with a portion of the joystick tool 140 other than the joystick 142. For instance, the user may select within the bounding area 130 at a position that does not include the joystick 142.

At decision block 254, the processor core complex 12 may determine whether the user input is indicative of a special region. For example, as described above with respect to FIG. 20, the special regions may be defined by the lines 228 and also include the center region 236. When the processor core complex 12 determines that the user input is indicative of a special region, at process block 256, the processor core complex 12 may identify a jump position associated with the special region indicated by the user input. For example, each special region may be associated with a particular position within the productivity document 102. For example, a top-left corner within the bounding area 130 may correspond to top-left corner portion of the productivity document 102. In some embodiments, the jump position may be based on populated portions (e.g., cells, pages, slides) of the productivity document 102, while in other embodiments, the jump positions may correspond to a length or width of the productivity document 102.

At process block 258, the processor core complex 12 may adjust the viewable portion of the productivity document to the jump position. In other words, the processor core complex 12 may cause the portion of the productivity document 102 associated with the user input to be displayed. For example, as described above, processor core complex 12 may cause the viewable portion of the productivity document 102 being displayed to change to a different viewable portion of the productivity document 102 without showing a transition between the two viewable portions.

If at decision block 254 the processor core complex 12 determines that the user input is not indicative of a special region, at process block 256, the processor core complex 12 may identify a jump position based on a vector. More specifically, the processor core complex 12 may determine a vector based on the user input and determine a jump position based on the vector. For example, when the user input indicates a portion of the central region 232, the processor core complex 12 may determine a vector (e.g., having a magnitude and direction). The vector may be determined similarly as discussed above. For instance, the magnitude of the vector may be determined based on how far from the center region 236 or a center point of the bounding area 130 the user input is, while a direction of the vector may be determined based on the location of the input relative to the center region 236 or center point of the bounding area 130 (e.g., left, right, up, down, or a combination thereof).

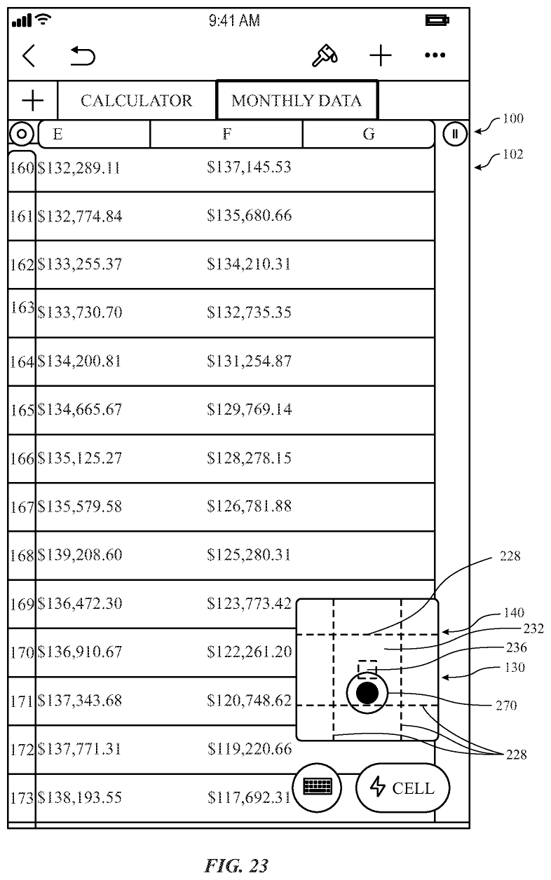

Based on the vector, the processor core complex 12 may determine a jump position. For example, the processor core complex 12 may determine a portion of the productivity document 102 to display based on the vector. More specifically, the vector may correspond to a movement from a currently displayed viewable portion of the productivity document 102, and the processor core complex 12 may display another viewable portion of the productivity document 102 based on a portion of the productivity document 102 indicated by the vector relative to the viewable portion of the productivity document 102 being displayed before the transition to the other viewable portion. For instance, FIG. 23 illustrates a user interaction (e.g., user input 270) with the central region 232 of the joystick tool 140. In response to receiving the user input 270, the processor core complex 12 may determine a vector.

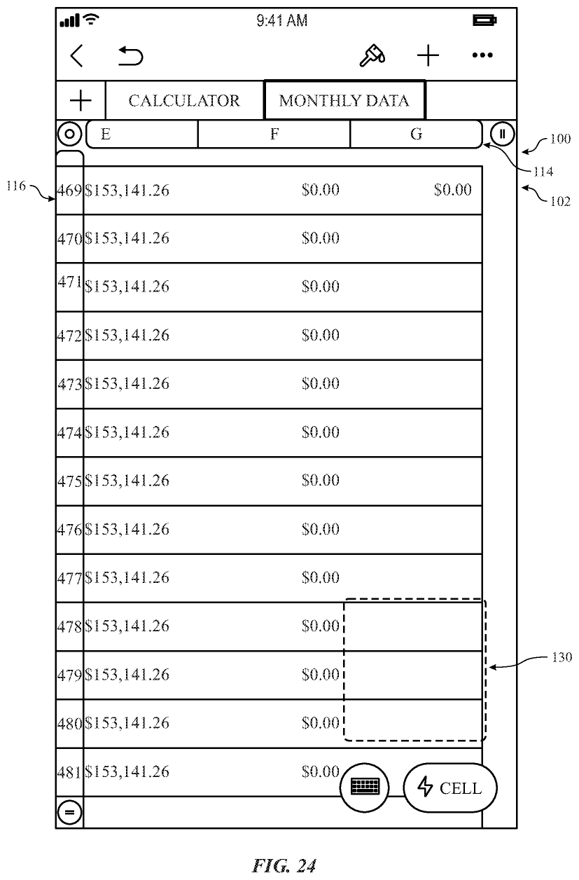

Additionally, at process block 258, the processor core complex 12 may adjust the viewable portion of the productivity document to the jump position determined based on the vector. In other words, the processor core complex 12 may cause the portion of the productivity document 102 associated with the user input to be displayed. For example, as described above, processor core complex 12 may cause the viewable portion of the productivity document 102 being displayed to change to a different viewable portion of the productivity document 102 without showing a transition between the two viewable portions. With this in mind, FIG. 24 shows a viewable portion of the productivity document 102. More specifically, in response to receiving the user input 270 illustrated in FIG. 23, the processor core complex 12 may display the viewable portion illustrated in FIG. 24. In particular, and as indicated by the column indicator 114, the viewable portion of the productivity document 102 shown in FIG. 24 is located below the viewable portion of the productivity document shown in FIG. 23.

In some embodiments, the processor core complex 12 may determine a type of user interaction within the bounding area 130 and utilize the type of interaction in determining a viewable portion of the productivity document 102 to present. For example, different interactions with the special regions may cause different viewable portions to be displayed. For instance, in one embodiment, a user may double-tap a special region, and a jump to a viewable portion of the productivity document 102 associated with the special region may be performed. However, when the user continuously selects (e.g., performs a long press) on a special region, the viewable portion may transition to another viewable portion similar to when the joystick 142 is utilized. For example, it may appear as though there is a sliding within the productivity document 102 in a direction corresponding to the special region indicated by the user input, and the visual indicator 150 and portion indicator 152 may be displayed. As another example, certain interactions with the center region 236 may cause a previously displayed viewable portion (e.g., prior to the most recent joystick-142 based movement) to be displayed. For instance, if a first viewable portion was displayed, then a second viewable portion was displayed, a user may interact with the center region 236 (e.g., double-tap, short-press, or another type of interaction) to cause the first viewable portion to be displayed. As yet another example, a user may interact with the central region 232 to cause a relatively short jump to occur.

In some embodiments, the user may interact with the joystick tool 140 to disable the joystick tool 140 and/or the joystick 142 or otherwise cause the joystick tool 140 and/or joystick 142 to no longer be displayed. For example, in one embodiment, a user could select the joystick 142 without moving the joystick 142 and/or swipe up passed a boundary of the bounding area 130, and the processor core complex 12 may interpret the user input as a request to stop displaying the joystick 142 and stop displaying the joystick tool 140 and/or joystick 142. With the joystick 142 not displayed, the user may be able to better interact with the embodiment of the joystick tool 140 illustrated in FIG. 23 (e.g., the joystick tool 140 without the joystick 142).

Moreover, the processor core complex 12 may cause the electronic device 10 to provide feedback, such as visual and/or haptic feedback to alert a user that an input is acknowledged. For example, as discussed above, the visual indicator 150 may be displayed based on a user's interaction with the joystick 142. Additionally, the electronic device 10 may vibrate otherwise provide haptic feedback in response to receiving user input. For example, in response to receiving a user input indicative of an interaction with or selection of a special region, the processor core complex 12 may cause the electronic device 10 to vibrate in addition to causing a new viewable portion of the productivity document 102 to be determined and displayed.

Furthermore, while the joystick tool 140 is described as being provided by the software application program 100, in other embodiments, the joystick tool 140 may be included in a software development kit (SDK) associated with electronic device 10 or software included on, or associated with, the electronic device 10. For example, the joystick tool 140 may be included as part of a SDK included with an operating system of the device or a software package or a software platform that may be included on, or accessible to, the electronic device 10. Accordingly, in some cases the joystick tool 140 may be utilized with software or applications other than the software application program 100.

The technical effects of the present disclosure include a joystick tool 140 that may be utilized to navigate within a productivity document 102 executed via a software application program 100. More specifically, the joystick tool 140 may be presented on a display 18 of an electronic device 10 with the productivity document 102, and a user of the electronic device 10 may interact with the joystick tool 140 to navigate within the productivity document 102. For instance, the joystick tool 140 may include a joystick 142 that the user may interact with to cause a viewable portion of the productivity document 102 that is displayed to transition to another viewable portion of the productivity document 102. Additionally, a user may select within a bounding area 130 associated with the joystick tool 140 to cause the viewable portion of the productivity document 102 to jump to another viewable portion of the productivity document 102. Accordingly, a user may be able to navigate through the productivity document 102 in a convenient and intuitive manner, especially on electronic devices with relatively small displays and/or electronic devices that do not utilize input structures typically associated with computers, such as keyboards, mice, and/or trackpads.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A method for adjusting a viewable portion of a productivity document in a document authoring application, the method comprising:
displaying, on a display, at least a portion of a productivity document having an associated bounding area;
displaying, at a location within the productivity document, a joystick tool having an associated bounding area smaller than the productivity document bounding area;
receiving a user input within the bounding area of the joystick tool;
determining a document navigational operation based on the user input; and
adjusting a viewable portion of the productivity document from a first viewable portion to a second viewable portion based on the document navigational operation, wherein the second viewable portion of the productivity document differs from the first viewable portion.

2. The method of claim 1, comprising displaying a visual indicator while transitioning from displaying the first viewable portion to displaying the second viewable portion, wherein the visual indicator indicates a direction of the second viewable portion relative to the first viewable portion.

3. The method of claim 2, wherein the productivity document comprises a spreadsheet, and wherein the visual indicator indicates which rows, columns, or rows and columns within the spreadsheet are included within the second viewable portion.

4. The method of claim 3, wherein:
the joystick tool comprises a joystick;
the user input is indicative of moving the joystick tool from a first location to a second location; and
determining the document navigational operation comprises determining a vector based on a direction of the second location relative to point within the bounding area of the joystick tool and a distance between the point and the second location.

5. The method of claim 4, wherein a second distance between the first viewable portion and the second viewable portion corresponds to the distance between the first location and the second location.

6. The method of claim 4, wherein a size of the visual indicator corresponds to the distance between the first location and the second location.

7. A user interface feature in a document authoring application for adjusting a viewable portion of a productivity document, comprising:
a joystick tool presented on a display of an electronic device, wherein, in response to receiving user input within a bounding area of the joystick tool, the application is configured to:
determine a document navigational operation based on the user input; and
cause the display to adjust from displaying a first viewable portion of the productivity document to a second viewable portion of the productivity document that is different than the first viewable portion based on the document navigational operation.

8. The user interface feature of claim 7, wherein the document authoring application comprises a spreadsheet application.

9. The user interface feature of claim 7, wherein the document authoring application comprises a visual indicator, wherein the visual indicator indicates a direction of the second viewable portion relative to the first viewable portion.

10. The user interface feature of claim 9, wherein the visual indicator indicates which portion of the productivity document is included within the second viewable portion.

11. The user interface feature of claim 10, wherein the visual indicator indicates which portion of the productivity document is included within the second viewable portion by displaying rows, columns, or rows and columns within the productivity document that are included within the second viewable portion.

12. The user interface feature of claim 7, wherein the bounding area of the joystick tool is larger than a bounding area of the productivity document.

13. The user interface feature of claim 7, wherein:
the joystick tool comprises a joystick; and
the bounding area comprises a region indicative of one or more directions in which the joystick is configured be moved.

14. The user interface feature of claim 7, wherein, in response to receiving a user input indicative of a request to jump within the productivity document, the application is configured to cause the display to adjust from displaying the first viewable portion of the productivity document to directly displaying the second viewable portion of the productivity document.

15. The user interface feature of claim 14, wherein, in response to receiving a second user input indicative of a request to jump within the productivity document, the application is configured to cause the display to return to displaying the first viewable portion.

16. A tangible, non-transitory computer-readable medium comprising instructions that, when executed, are configured to cause one or more processors to:
display, on a display, at least a portion of a productivity document having an associated bounding area;
display, at a location within the productivity document, a joystick tool having an associated bounding area;
receive a user input within the bounding area of the joystick tool;
determine a document navigational operation based on the user input; and
adjust a viewable portion of the productivity document from a first viewable portion to a second viewable portion based on the document navigational operation, wherein the second viewable portion of the document differs from the first viewable portion.

17. The tangible, non-transitory computer-readable medium of claim 16, wherein the user input is indicative of a user selecting a region within the bounding area of the joystick tool.

18. The tangible, non-transitory computer-readable medium of claim 17, wherein the instructions, when executed, are configured to cause the one or more processors to determine a portion of the productivity document corresponding to the second viewable portion based on the user input.

19. The tangible, non-transitory computer-readable medium of claim 16, wherein the instructions, when executed, are configured to cause one or more processors to display a joystick within the bounding area of the joystick tool, wherein the user input is indicative of a user interacting with the joystick.

20. The tangible, non-transitory computer-readable medium of claim 16, wherein the tangible, non-transitory computer-readable medium is included in a tablet computer, a phone, or a watch.
